(19) United States
(12) Patent Application Publication
(10) Pub. No.: US 2013/0198095 A1
(43) Pub. Date: Aug. 1, 2013

(54) Method and Device for Automatically Evaluating a Delivery System

(71) Applicants: Sigrid Achner, Aachen (DE); Claus Blankertz, Aachen (DE); Birgit Heftrich, Rottenbach/Erlangen (DE); Jens-Christian Holst, Berlin (DE); Katrin Müller, Berlin (DE); Frank Walachowicz, Berlin (DE); Karin Übelhör, Berlin (DE)

(72) Inventors: Sigrid Achner, Aachen (DE); Claus Blankertz, Aachen (DE); Birgit Heftrich, Rottenbach/Erlangen (DE); Jens-Christian Holst, Berlin (DE); Katrin Müller, Berlin (DE); Frank Walachowicz, Berlin (DE); Karin Übelhör, Berlin (DE)

(21) Appl. No.: 13/818,375

(22) PCT Filed: Aug. 5, 2011
(86) PCT No.: PCT/EP2011/063531

§ 371 Date: Apr. 16, 2013

(30) Foreign Application Priority Data
Aug. 27, 2010 (DE) 10 2010 036 292.1

(51) Int. Cl. G06Q 30/00

(52) U.S. Cl. CPC G06Q 30/018
USPC 705/317

(57) ABSTRACT

A method for automatically evaluating a delivery system with respect to the energy efficiency and emissions efficiency thereof, may include: determining a service level for the delivery system according to an energy intensity and an evaluation relevance of the particular delivery system, detecting energy data and emissions data of the delivery system corresponding to the determined service level of the delivery system, and calculating at least one indicator based on the detected energy data and emissions data and/or based on data for the energy management and environmental management of the delivery system for evaluating the delivery system with respect to the energy efficiency and emissions efficiency thereof.

### CROSS-REFERENCE TO RELATED APPLICATIONS

This application is a U.S. National Stage application of International Application No. PCT/EP2011/063531 filed Aug. 5, 2011, which designates the United States of America, and claims priority to DE Patent Application No. 10 2010 036 292.1 filed Aug. 27, 2010 The contents of which are hereby incorporated by reference in their entirety.

### TECHNICAL FIELD

The disclosure relates to a method and a device for automatically evaluating a delivery system or a delivery site, respectively, with regard to the extent of its energy efficiency and emissions.

### BACKGROUND

In the evaluation of delivery systems and delivery sites, respectively, by a buyer, technical and business considerations are normally used. The conventional methods for evaluating delivery systems do not sufficiently consider the effects of a delivery system having a low energy efficiency and high emissions into the environment. In industries using a high amount of energy, in particular, for example in steel production, an inefficient production of the respective product, for example steel, can lead to the environment being burdened considerably. In this context, environmental burdens are direct emissions of climate-damaging gases such as CO₂, methane or ozone, but also indirect environmental damage which arises during the production of the energy, for example due to the extraction of sources or acidification of the soil. Further environmental damage arises also due to various emissions, for example rays, for example radioactive radiation or also noise emission or due to acoustic emissions.

Previous evaluation methods for delivery systems or delivery sites also do not offer any comparability of various delivery sites with respect to the extent of their energy efficiency and emissions, especially no comparison with an industry average.

### SUMMARY

One embodiment provides a method for automatically selecting a delivery system with regard to its energy and emission efficiency, having the steps: (a) determining a service level reflecting the environmental relevance for the delivery systems in dependence on an energy intensity depending on the use of energy and an evaluation relevance, depending on the delivery volume, of the respective delivery system; (b) acquiring energy and emission data of the delivery systems in accordance with the determined service level of the respective delivery system; (c) calculating in each case at least one indicator based on the acquired energy and emission data or based on the acquired energy and emission data and data relating to the energy and environmental management of the respective delivery system for the evaluation of the delivery system with regard to its energy and emission efficiency; and (d) selecting delivery systems with indicators which indicate a high energy and emission efficiency, for the delivery.

In a further embodiment, this method runs on a computer.

In a further embodiment, an environmental and energy efficiency priority value is calculated for the respective delivery system from the stored indicators of the delivery systems which provide the same products or services to a buyer.

In a further embodiment, at least one delivery system is selected automatically by a server of a buyer in dependence on the calculated environmental and energy efficiency priority values of the delivery system.

In a further embodiment, an industry indicator is calculated on the basis of energy and emission data of a multiplicity of delivery systems of the same industry which are stored in a database.

In a further embodiment, a difference between the calculated indicator of the delivery system and the industry indicator of the corresponding industry is calculated and is conveyed to the delivery system as industry benchmark value.

In a further embodiment, the energy and emission data of the delivery system are measured at least partially by measuring sensors which are provided in the delivery system and are transmitted to a server of a buyer or of an evaluation entity via a data network.

In a further embodiment, the energy and emission data and information relating to energy and environmental management are input partially by means of a predetermined input mask via an input interface and are transmitted to the server of the buyer or of the evaluation entity via the data network.

In a further embodiment, a data consistency of the energy and emission data input and of the environmental and management data input is checked automatically by the server.

In a further embodiment, the procurement of a product or of a service is switched automatically to the selected delivery system by the server of the buyer.

In a further embodiment, a volume of data of the acquired energy and emission data and of the input environmental and management data of the delivery system is set in dependence on the determined service level of the delivery system.

In a further embodiment, the energy intensity of the delivery system is determined by the energy which is consumed by the delivery system per volume of the products or services provided to the buyer.

In a further embodiment, the evaluation relevance of the delivery system is determined by the proportion of the products or services provided to the buyer by the delivery system of a total volume of these products or services.

Another embodiment provides a non-transitory data medium on which a computer program is stored which can perform a method as disclosed above.

Another embodiment provides a delivery management device with a data processing facility having (a) a service level determining unit which determines a service level, reflecting the environmental relevance, for a delivery system in dependence on an energy intensity, provided via an interface, of the delivery system which is dependent on the use of energy and on an evaluation relevance, provided via the interface, of the delivery system which is dependent on the delivery volume; (b) an energy and emission data acquisition unit, connected to the service level determining unit, which, via an interface, acquires energy and emission data of the delivery system in accordance with the determined service level of the delivery system; and (c) a calculating unit, connected to the emission data acquisition unit, which calculates at least one indicator based on the acquired energy and emission data and/or based on information relating to the energy and environmental management of the delivery system for evaluating the delivery system with regard to its energy and emission efficiency, having an interface for outputting the indicator.

In a further embodiment, the energy and emission data are acquired by measuring sensors which are provided in the delivery system or are input by means of an input mask via an input interface.

In a further embodiment, the delivery management device has access to a database in which energy and emission data and environmental and management data of a multiplicity of delivery systems are stored for various industries.

### BRIEF DESCRIPTION OF THE DRAWINGS

Exemplary embodiments will be explained in more detail below on the basis of the schematic drawings, wherein:

FIG. 1 shows a simple flowchart for representing an example embodiment of a method for automatically evaluating a delivery system;

FIG. 2 shows a diagram for representing an exemplary embodiment of a system having a delivery management device; and

FIG. 3 shows a block diagram for representing an exemplary embodiment of a delivery management device.

### DETAILED DESCRIPTION

Embodiments of the present disclosure provide a method and a device for automatically evaluating a delivery system with respect to the extent of its energy efficiency and emissions.

Some embodiments provide a method for automatically evaluating a delivery system with regard to the extent of its energy efficiency and emissions by means of the steps:

determining a service level for the delivery system in dependence on an energy intensity and an evaluation relevance of the respective delivery system,
acquiring energy and emission data of the delivery system in accordance with the service level of the delivery system determined, and
calculating at least one indicator based on the acquired energy and emission data and/or based on information relating to the energy and environmental management of the delivery system for evaluating the delivery system with regard to the extent of its energy efficiency and emissions.

The method may thus allow an automatic evaluation of a delivery system or of a delivery site with regard to possible savings in energy and emissions.

Depending on the evaluation determined, measures for reducing the energy consumption or for reducing the emissions can then be initiated.

The indicator can be, for example, so called CO₂ equivalents or a so called carbon footprint of the delivery system.

In one embodiment of the method, an environmental and energy efficiency priority value is calculated for the respective delivery system from the calculated indicator of the delivery system and stored indicators of other delivery systems which provide the same products or services to a buyer.

In one embodiment of the method, at least one delivery system is selected automatically by a server of a buyer in dependence on the calculated environmental and energy efficiency priority values of the various delivery systems.

Preferably, a delivery system having a high environmental and energy efficiency priority value which indicates a high energy and emission efficiency of the delivery system is selected automatically by the buyer as the preferred provider and thus for further delivery of the products or services to him. Other delivery systems which have a low environmental and energy-efficiency priority value can be filtered out correspondingly so that they supply the buyer no longer, or only to a small extent, with corresponding products and services in future.

In one embodiment of the method, an industry indicator is calculated for the corresponding industry on the basis of energy and emission data of a multiplicity of delivery systems of the same industry which are stored, for example, in a database.

In one embodiment of the method, a difference between the calculated indicator of the delivery system and the industry indicator of the corresponding industry is calculated and is conveyed to the delivery system as industry benchmark.

Conveying the indicator of the delivery system and of the associated industry indicator can take place, for example, via a data network from the server of the buyer to a computer of the delivery system. In this manner, the management of the delivery system obtains a comparison value for the industry benchmark value of the corresponding industry and can thus recognize its own position in comparison with the industry and possibly take corresponding measures.

In one embodiment of the method, the energy and emission data of the delivery system are acquired at least partially by measuring sensors or sensorially, respectively. The measuring sensors are located preferably in the area of the delivery system. In this context, the measuring sensors preferably delivery corresponding energy and emission data via a data network to a server of a buyer or of an independent evaluation entity.

In one embodiment of the method, the energy and emission data and information relating to energy and environmental management are input partially by means of a predetermined input mask via an input interface and are transmitted to the server of the buyer or of the evaluation entity via a data network.

The data are thus evaluated either at the buyer of the products or services which are delivered by the various delivery systems, or by an independent evaluation entity, for example a governmental or international authority.

In one embodiment of the method, a data consistency of the energy and emission data input and of the energy and environmental management data input checked automatically by the server.

In one embodiment of the method, the procurement of a product or of a service is switched automatically to one or more selected delivery systems by the server of the buyer.

In one embodiment of the method, a volume of data of the acquired energy and emission data and of the acquired environmental and management data of the delivery system is set or adapted in dependence on the determined service level of the delivery system.

In one embodiment of the method, the higher the determined service level of the delivery system, the more data are acquired.

In one embodiment of the method, the intensity of the delivery system is determined by the energy which is consumed by the delivery system per volume of the products or services provided to the buyer.

In one embodiment of the method, the evaluation relevance of the delivery system is determined by the proportion of products or services which the delivery system provides from a total quantity of these products or services to the buyer.

Other embodiments provide a delivery management device comprising
a service level determining unit which determines a service level for a delivery system in dependence on an energy intensity and on an evaluation relevance of the delivery system,
an energy and emission data acquisition unit which acquires energy and emission data of the delivery system in accordance with the determined service level of the delivery system and comprising
a calculating unit which calculates at least one indicator based on the acquired energy and emission data and/or based on information relating to the energy and environmental management of the delivery system for evaluating the delivery system with regard to energy efficiency and extent of emissions.

In one embodiment of the delivery management device, the energy and emission data are acquired by measuring sensors which are provided in the delivery system, or are input by means of an input mask via an input interface.

In one embodiment of the delivery management device, the delivery management device has access to a database in which energy and emission data and energy and environmental management information of a multiplicity of delivery systems are stored for various industries.

As can be seen from FIG. 1, an example method for automatically evaluating a delivery system with regard to the extent of its energy efficiency and emissions essentially has three steps.

In a first step S1, a service level SL is initially determined for the respective delivery system in dependence on an energy intensity EI and an evaluation relevance ER of the respective delivery system. Preferably, four different service levels SL are provided depending on the energy intensity EI and evaluation relevance ER. In this context, the energy intensity EI of the delivery system is preferably determined by the energy which is consumed by the delivery system per quantity of products or services provided to the buyer. The energy intensity EI of the delivery system can also be referred to the energy used per turnover achieved by the supplier with the buyer for the respective product or the respective service. The energy can be specified, for example, in kilojoules.

The evaluation relevance ER of the delivery system which is used in step S1 for determining the service level of the delivery system is preferably determined by the proportion of the products or services which is provided by the delivery system to the buyer of a total quantity of these products or services. In one possible embodiment, the evaluation relevance ER depends, for example, on the supplier's proportion of the turnover for the respective product or the respective service in the total turnover for these products and services procured by the buyer. The higher the energy intensity EI and the evaluation relevance ER of a delivery system, the higher the environmental relevance of this site or of this delivery system, respectively, with regard to a possible impairment of the environment from the point of view of the buyer.

In one embodiment, the higher the relevance of the respective delivery system to the environment, the higher the selected service level SL.

In a further step S2, the energy and emission data of the delivery system are acquired in accordance with the determined service level SL of the delivery system. Furthermore, data can be acquired with the step S2 with regard to the energy and environmental management of the delivery system in dependence on the determined service level SL.

In one embodiment of the method, the energy and emission data of the delivery system are acquired at least partially sensorially by measuring sensors. The measuring sensors are provided in the delivery system or in the area of the delivery system, respectively. In one embodiment, the measuring sensors are connected via a data network to a server of a buyer or of an evaluating entity and transmit measurement data or energy and emission data of the respective delivery system. In one possible embodiment, the measuring sensors form a network of sensors. The sensors can communicate with one another, for example, via wireless LAN links. The sensors can also be connected to a LAN network of the respective supplier or enterprise.

The network of sensors can comprise a multiplicity of different sensors which measure different environmental parameters. For example, sensors can sensorially acquire a CO₂ content of the environment in the area of the delivery system. Other examples are sensors for acquiring the nitrogen content or other chemical pollutants, e.g. greenhouse gases. In addition, the sensors can also acquire other emissions of the delivery system. For example, sensors can acquire emissions such as CO₂ or ozone or any possible radioactive radiation or other rays and inform the server of the buyer or of the evaluation entity via the data network. Another example are sensors which acquire acoustical noise loads.

In one embodiment, these energy and emission data are transmitted to the server in real time and thus allow monitoring.

In one embodiment, the energy and emission data and the information relating to the energy and environmental management are input partially via an input interface by means of one or more predetermined input masks or templates. The input interface can be located, for example, at the delivery system. The input interface is typically provided at a terminal of the delivery system. This terminal is connected preferably to the server of the buyer or to the server of an evaluation entity via a data network and transmits the energy and emission data input and information relating to the energy and environmental management input to the server. The server preferably automatically checks a data consistency of the energy and emission data input and of the environmental and management data input. This makes it possible to detect wrong inputs.

In a further step S3, at least one indicator is calculated based on the acquired energy and emission data and based on the data relating to energy and environmental management of the delivery system for evaluating the delivery system with regard to the extent of its energy efficiency and emissions. The calculation can be carried out, for example, by the server of the buyer. As an alternative, the calculation can be carried out by the server of an independent evaluation entity, for example an authority. In one possible embodiment, an environmental and energy efficiency priority value is in addition calculated for the respective delivery system in step S3 on the basis of the calculated indicator of the delivery system and based on stored indicators of other delivery systems which provide the same or comparable products or services to the buyer. In this context, in one possible embodiment, the server has access to a database in which energy and emission data of a multiplicity of delivery systems of the same industry are stored. In this database, stored information relating to the energy and environmental management of the respective delivery systems can also be located. In one possible embodiment, the server has access to a local database in which the energy and emission data and the energy and environmental management information relating to the delivery systems of different industries are stored.

In one alternative embodiment, the server has access to a database having the corresponding information via a data network. In one embodiment of the method, a difference between the calculated indicator of the delivery system and the calculated industry indicator for the corresponding industry is additionally calculated in step S3 and conveyed as industry benchmark to the delivery system via a data network. In this manner, the management of the delivery system receives information about how its own delivery system is evaluated with regard to the extent of energy efficiency and emissions in an industry comparison.

In one embodiment, one or more delivery systems are selected automatically by a server of a buyer in dependence on the calculated environmental and energy efficiency priority values of the delivery systems.

In this embodiment, the delivery systems having an associated environmental and energy efficiency priority value are also filtered out automatically and the buyer procures products or services only from those delivery systems which have a high environmental and energy efficiency priority value. In one possible embodiment, the procurement of a product or of a service is even switched automatically to the selected delivery systems by the server of the buyer. This can take place, for example, with a continuous flow of material which exists from the delivery system to the buyer, for example in the case of procurement of gases or of another fluid or raw materials by a buyer. The environmental or energy efficiency priority values of a delivery system can be calculated in dependence on one or more indicators of the delivery system. The indicators can be, for example, CO₂ equivalents.

In the case of the disclosed method, this can be carried out, for example, as a program by a server of the buyer or of an independent evaluation entity. In this embodiment, a supplier can procure or download such an evaluation program from the server of the buyer and independently carry out a self evaluation additionally. By means of continuous measures for increasing the energy efficiency and reduction of emissions, the supplier is capable in this way to monitor any possible progress or an improvement of his environmental and energy efficiency priority values.

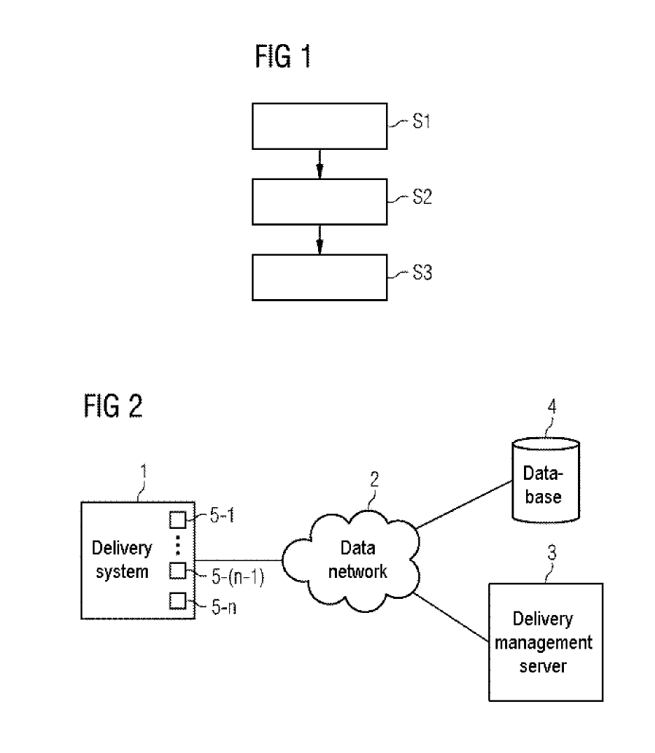

FIG. 2 shows a diagram for representing an exemplary embodiment of a system which uses a delivery management device. In this context, a computer of a delivery system 1 is connected to a delivery management server 3 of the buyer via a data network 2. Computers of different delivery systems of the same or different industries can be connected to the data network 2. Furthermore, one or more databases 4 which can be accessed by the delivery management server 3 are connected to the data network 2. In this database 4, energy and emission data and energy and environmental management data of a multiplicity of delivery systems of the same industries are stored, for example. The database 4 can store data for one or more industries. For example, one industry comprises all the relevant manufacturers of steel. As shown in FIG. 2, measuring sensors 5-i which supply energy and emission data to the delivery system 1 can also be provided in the delivery system 1. These energy and emission data are transmitted by the measuring sensors 5-i of the delivery system 1 to the server 3 via the data network 2. In this context, the transmission takes place preferably in a manipulation-proof manner, for example cryptographically protected or via a VPN tunnel. In one possible embodiment, the measuring sensors 5-i are operated under control of the delivery management server 3 so that manipulations on site at the delivery system 1 are largely avoided. In one possible embodiment, the measuring sensors 5-i are installed by the buyer himself in the area of the delivery system 1 or attached there.

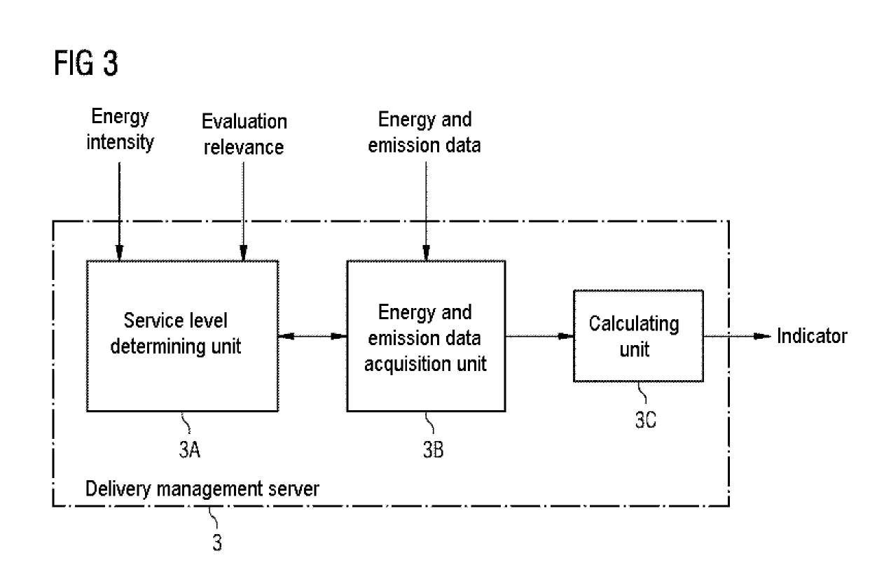

FIG. 3 shows a block diagram of one possible embodiment of the delivery management device 3 which, for example, is implemented on a server 3 of the buyer or an independent evaluation entity. As can be seen from FIG. 3, the delivery management device 3 has a service level determining unit 3A which determines a service level SL for a delivery system 1 in dependence on an energy intensity EI and an evaluation relevance ER of the delivery system 1. In this context, an energy intensity EI and an evaluation relevance ER of the respective delivery system 1 can be input, for example via an interface, especially a user interface. In one possible embodiment, the energy intensity EI and the evaluation relevance ER are read out of a local memory of the server 3.

The service level determining unit 3A is connected to an energy and emission data acquisition unit 3B. The energy and emission data acquisition unit 3B acquires the energy and emission data of the delivery system 1 in accordance with the determined service level SL of the delivery system 1. In this context, the volume of data of the acquired energy and emission data and of the input environmental and management data of the delivery system 1 can be set in dependence on the determined service level SL of the delivery system 1. For example, in the case of a delivery system 1 having a high service level SL or a high environmental relevance, more data are acquired than in the case of a delivery system 1 having a low service level SL or a low environmental relevance. The energy and emission data acquisition unit 3B obtains the energy and emission data, for example, at least partially from the measuring sensors 5-i provided in the delivery system 1. Furthermore, the energy and emission data acquisition unit 3B can obtain energy and emission data by means of a predetermined input mask via an input interface with a computer which is provided in the delivery system 1. In addition, the energy and emission data acquisition unit 3B also receives information relating to the energy and environmental management which is acquired via an input interface by means of a predetermined input mask and is transmitted to the energy and emission data acquisition unit 3B, e.g. via the data network 2. In an alternative embodiment, the energy and emission data and the energy and environmental management information are transmitted off-line or by transmitting a data carrier to the delivery management server 3 which reads the data out of the data carrier by means of a reader.

As can be seen from FIG. 3, the delivery management device 3 has additionally a calculating unit 3C. The calculating unit 3C calculates at least one indicator based on the acquired energy and emission data and based on information relating to the energy and environmental management of the delivery system 1 for the evaluation of the delivery system with regard to its energy and emission efficiency. The calculating unit 3C carries out, for example, a predetermined evaluation algorithm which is loaded from a program memory. The calculating unit 3C can calculate one or more indicators corresponding to the evaluation algorithm. The indicator is, for example, CO₂ equivalents. In addition, the calculating unit 3C can provide the calculations with the aid of the indicator of the delivery system 1 and other stored indicators of other delivery systems which provide the buyer with the same products and services, additionally calculate an environmental and energy efficiency priority value for the respective delivery system 1. On the basis of energy and emission data and energy and environmental management data of a multiplicity of delivery systems 1 of the same industry, the calculating unit 3C can also calculate an industry indicator. Furthermore, the calculating unit 3C calculates in one possible embodiment a difference between the calculated indicator of the delivery system 1 and the calculated industry indicator of the corresponding industry. The industry indicator is preferably conveyed as industry benchmark value to the respective delivery system 1 via the data network 2. The delivery system 1 can then perform the necessary measures for enhancing the energy and emission efficiency. The calculating unit 3C can contain one or more microprocessors or CPUs, the evaluation of the energy and emission data and of the energy and environmental management data being performed in real time in one possible embodiment. In one possible embodiment, the delivery system 1 is selected automatically for further delivery of products and services to the buyer in dependence on the environmental and energy efficiency priority value of the delivery system 1 calculated by the calculating unit 3C. On the other hand, too low an environmental and energy efficiency priority value can also lead to an automatic filtering-out of the delivery system 1. The automatic selection can occur especially in industries in which similar or comparable products can be procured by the buyer from a multiplicity of different delivery systems.

A buyer who procures products or services from different delivery systems 1 produces a product or a service which he provides himself in the chain of value creation to a customer. This means that, in this case, the buyer himself becomes a supplier for the next stage in the chain of value creation. A delivery management system as shown in FIG. 2 is suitable not only for a single-stage delivery/buyer relation but also for a multi-link chain of suppliers within a chain of value creation. In the example shown in FIG. 2, for example, the delivery system 1 itself can have a delivery management device in order to evaluate suppliers for its part. A buyer who provides the end product for customers can correspondingly identify his products or services, for example by pointing to the fact that his products or services have been produced in an especially environmentally friendly way.

The disclosed system may allow energy and emission saving potentials to be identified, analyzed and transparently represented especially in production sites. As a result of this, the energy consumption and the volume of emissions can be lowered.

The disclosed method having the automatic evaluation performed for a delivery system 1 can be offered as a service for the supplier 1 by the buyer on his part. The method for automatically evaluating a delivery system 1 may comprise a uniform principle with respect to a total environmental evaluation. In this context, the evaluation can extend over several links of the chain of value creation. By means of the disclosed system, a uniform energy efficiency and environmental evaluation system is created, especially for industrial sites of all industries and orders of magnitude with a range of services appropriate to the environmental relevance.

In one further embodiment of the method of the delivery system 1, it is not only an energy efficiency priority value having the corresponding industry benchmark value which is provided but additionally a corresponding list of measures. By providing various service levels SL, a scalability is achieved which enables delivery systems or delivery sites which have a different environmental relevance to be evaluated. In addition, a list of measures with corresponding recommendations can be generated automatically for each service SL.

The evaluation method may be used for reducing the total energy consumption and thus also the total emission value of delivery sites. The buyer has the option of performing a corresponding auditing of his suppliers and aligning complete processes in a more energy-efficient manner over the entire chain of value creation. In addition, the buyer has the option of checking individual suppliers with respect to their energy and emission efficiency and comparing them with an industry benchmark value. Suppliers who are above the industry benchmark value can preferably be developed further by the buyer by demonstrating measures and corresponding target agreements and the processes can thus be aligned effectively in a manner which preserves resources. The operator additionally obtains information with regard to his own carbon footprint or indicator, respectively, and additionally an evaluation of how he is doing in an industry comparison. By means of the measures shown, the supplier additionally has the option of reducing his own consumption of resources, wherein it is not only his environmental performance which is improved in this manner but additionally resources or costs can also be saved.

The disclosed system may thus provide a combined scalable energy efficiency and environmental evaluation system which can also be used in a manner spanning various sectors of industry.

What is claimed is:

1. A computer-implemented method for automatically selecting at least one delivery system from a plurality of delivery systems based on energy and emission efficiency, the method comprising:
for each delivery system, determining a service level reflecting an environmental relevance for that delivery system based on an energy intensity depending on the use of energy and an evaluation relevance, depending on a delivery volume, of that delivery system;
for each delivery system, acquiring energy and emission data of that delivery system based on the determined service level of that delivery system;
for each delivery system, calculating at least one indicator based on the acquired energy and emission data or based on the acquired energy and emission data and data relating to that energy and environmental management of that delivery system for the evaluation of that delivery system with regard to its energy and emission efficiency; and
selecting one or more delivery systems with indicators that indicate a high energy and emission efficiency, for the delivery.

2. (canceled)

3. The method of claim 1, wherein an environmental and energy efficiency priority value is calculated for each delivery system based on stored indicators of the delivery systems that provide the same products or services to a buyer.

4. The method of claim 3, wherein at least one delivery system is selected automatically by a server of a buyer based on the calculated environmental and energy efficiency priority values of that delivery system.

5. The method of claim 1, wherein an industry indicator is calculated based on energy and emission data of multiple delivery systems of the same industry that are stored in a database.

6. The method of claim 5, wherein a difference between the calculated indicator of the delivery system and the industry indicator of the corresponding industry is calculated and communicated to the delivery system as an industry benchmark value.

7. The method as claim 1, wherein the energy and emission data of the delivery system are measured at least partially by measuring sensors that are provided in the delivery system and are communicated to a server of a buyer or of an evaluation entity via a data network.

8. The method of claim 7, wherein the energy and emission data and information relating to energy and environmental management are input partially using a predetermined input mask via an input interface and are transmitted to the server of the buyer or of the evaluation entity via the data network.

9. The method of claim 8, wherein a data consistency of the energy and emission data input and of the environmental and management data input is checked automatically by the server.

10. The method of claim 4, wherein the procurement of a product or of a service is switched automatically to the selected delivery system by the server of the buyer.

11. The method of claim 1, wherein a volume of data of the acquired energy and emission data and of the input environmental and management data of the delivery system is set based on the determined service level of the delivery system.

12. The method of claim 1, wherein the energy intensity of the delivery system is determined by the energy which is consumed by the delivery system per volume of the products or services provided to the buyer.

13. The method of claim 1, wherein the evaluation relevance of the delivery system is determined by the proportion of the products or services provided to the buyer by the delivery system of a total volume of these products or services.

14. A Computer program product for automatically selecting at least one delivery system from a plurality of delivery systems based on based on energy and emission efficiency, the computer program product stored in non-transitory data medium and executable by a processor to:
for each delivery system, determine a service level reflecting an environmental relevance for that delivery system based on an energy intensity depending on the use of energy and an evaluation relevance, depending on a delivery volume, of that delivery system;
for each delivery system, acquire energy and emission data of that delivery system based on the determined service level of that delivery system;
for each delivery system, calculate at least one indicator based on the acquired energy and emission data or based on the acquired energy and emission data and data relating to the energy and emission data and data relating to the energy and environmental management of that delivery system for the evaluation of that delivery system with regard to its energy and emission efficiency; and
select one or more delivery systems with indicators that indicate a high energy and emission efficiency, for the delivery.

15. A delivery management device having a data processing facility comprising:
a service level determining unit which determines a service level, reflecting the environmental relevance, for a delivery system based on an energy intensity, provided via an interface, of the delivery system which is dependent on the use of energy and on an evaluation relevance, provided via the interface, of the delivery system which is dependent on the delivery volume;
an energy and emission data acquisition unit connected to the service level determining unit and which acquires energy and emission data of the delivery system via an interface in accordance with the determined service level of the delivery system;
a calculating unit connected to the emission data acquisition unit, and which calculates at least one indicator based on the acquired energy and emission data and/or based on information relating to the energy and environmental management of the delivery system for evaluating the delivery system with regard to its energy and emission efficiency, having an interface for outputting the indicator.

16. The delivery management device of claim 15, wherein the energy and emission data are acquired by measuring sensors which are provided in the delivery system or are input by an input mask via an input interface.

17. The delivery management device of claim 15, wherein the delivery management device has access to a database in which energy and emission data and environmental and management data of multiple delivery systems are stored for various industries.
